(19) United States
(12) Patent Application Publication
(10) Pub. No.: US 2012/0270435 A1
(43) Pub. Date: Oct. 25, 2012

(54) ELECTRICAL SAFETY PLUG WITH GRIP WINGS FOR ELECTRICAL PLUGS AND DATA CORD PLUGS

(76) Inventors: Jeramy Hale, Menlo Park, CA (US); Molly Ruth Hale, Menlo Park, CA (US)

(21) Appl. No.: 13/445,424

(22) Filed: Apr. 12, 2012

Related U.S. Application Data
(60) Provisional application No. 61/517,039, filed on Apr. 12, 2011.

(51) Int. Cl. H01R 13/62

(52) U.S. Cl. 439/476.1

(57) ABSTRACT

The grip wings provide a push/pull insertion and withdrawal of plugs that eliminates the need for grip strength; obvious visual and tactile alignment of plugs; a finger stop that is safely away from the prongs of the plug. These features are provided while preserving the original cord/plug integrity; adapting to the international variety of existing plugs; allowing fit in multiple close outlets; giving easy installation; and enduring for the life of the plug. The grip wings consist of a rigid bar positioned perpendicular to the line of the cord and plug, and an attachment of the bar to the plug. The grip wings can be provided as either an accessory to existing plugs or included in the original manufacturing of the plug. The grip wings are adaptable to consumer or industrial use. It is adaptable to options for shape, texture, appearance, self-illumination, and orientation to appeal to many markets.

### CROSS-REFERENCE TO RELATED APPLICATIONS

This application claims the benefit of provisional application Ser. No. 61/517,039, filed 2011 by the present inventors.

### BACKGROUND

### Prior Art

The following is a tabulation of some prior art that presently appear relevant:

Invention Description (use key words and variation):

Key words: Electrical safety plug w/grip wings; push/pull handle, grip wings, safety guard, and aligner for electrical plugs and data cord plugs.

Selected Search Classifications Thought Relevant

Patents and Other References Thought Relevant

| | | | | |
|---|---|---|---|---|
| Pat. No. | Filing date | Issue date | Original Assignee | Title |

2,396,901 Tiffany 1946

| | | | | |
|---|---|---|---|---|
| U.S. Pat. No. 4,445,739 | May 4, 1982 | May 1, 1984 | | Male plug with automatic prong cover |
| U.S. Pat. No. 5,030,119 | Sep. 27, 1989 | Jul. 9, 1991 | Safe Care Products, Inc. | Safety plug |
| U.S. Pat. No. 5,108,297 | Nov. 26, 1990 | Apr. 28, 1992 | Hubbell Incorporated | Positive locking electrical plug with |
| | | | | shielded blade protection |
| U.S. Pat. No. 5,178,552 | Aug. 14, 1991 | Jan. 12, 1993 | Yazaki Corporation | Connector |
| U.S. Pat. No. 5,328,387 | Nov. 1, 1993 | Jul. 12, 1994 | Hubbell Incorporated | Lockable cover for electrical connector |
| U.S. Pat. No. 5,599,196 | May 1, 1995 | Feb. 4, 1997 | | Electrical plug safety cover |
| U.S. Pat. No. 5,641,310 | Dec. 8, 1994 | Jun. 24, 1997 | Hubbell Incorporated | Locking type electrical connector with |
| | | | | retention feature |
| U.S. Pat. No. 5,680,926 | May 17, 1995 | Oct. 28, 1997 | Hubbell Incorporated | Mechanical interlock mechanism for |
| | | | | switched electrical connector |
| U.S. Pat. No. 5,741,149 | May 17, 1995 | Apr. 21, 1998 | Hubbell Incorporated | Shrouded locking type electrical |
| | | | | connector with locking member |
| U.S. Pat. No. 6,468,095 | Feb. 23, 2001 | Oct. 22, 2002 | Angelo Fan Brace | Electrical plug and receptacle having |
| | | | Licensing, L.L.C. | safety features |

2,490,580 Colla 1949

| | | | | |
|---|---|---|---|---|
| U.S. Pat. No. 5,085,591 | Nov. 5, 1990 | Feb. 4, 1992 | Safety plug with prong locks | |
| U.S. Pat. No. 5,628,641 | Nov. 3, 1995 | May 13, 1997 | Asian Micro Sources, Inc. | Collapsible plug |
| | | | | device for battery charger |
| U.S. Pat. No. 5,634,806 | Mar. 30, 1995 | Jun. 3, 1997 | Asian Micro Sources, Inc. | Interchangeable |
| | | | | collapsible plug device for battery charger |
| U.S. Pat. No. 5,684,689 | Jun. 19, 1996 | Nov. 4, 1997 | Advanced Mobile Solutions, Inc. | Interchangeable plug power supply with |
| | | | | automatically adjusting input voltage |
| | | | | receiving mechanism |
| U.S. Pat. No. 6,227,888 | Mar. 20, 1997 | May 8, 2001 | Advanced Mobile Solutions, Inc. | Interchangeable |
| | | | | plug device |
| U.S. Pat. No. 7,284,773 | Aug. 20, 2004 | Oct. 23, 2007 | Triumph Controls, Inc. | Quick disconnect with |
| | | | | retaining spring |
| USD381314 | Sep. 15, 1995 | Jul. 22, 1997 | Asian Micro Sources, Inc. | Interchangeable plug |
| | | | | device |

2,918,647 Britt 1959

Referenced By

| Pat. No. | Filing date | Issue date | Original Assignee | Title |
|---|---|---|---|---|
| U.S. Pat. No. 4,352,540 | Jul. 23, 1980 | Oct. 5, 1982 | | Electrical plug |
| U.S. Pat. No. 4,468,081 | Jul. 15, 1982 | Aug. 28, 1984 | Mitsubishi Denki Kabushiki | Terminal assembly for circuit |
| | | | Kaisha | interrupter |

3,753,205 Tuger 1973

| | | | | |
|---|---|---|---|---|
| U.S. Pat. No. 4,249,786 | Nov. 3, 1978 | Feb. 10, 1981 | Hydraflow Supply, Inc. | Flexible coupling |
| U.S. Pat. No. 4,332,404 | Aug. 27, 1980 | Jun. 1, 1982 | Metal Bellows Corp. | Flexible tubing coupling |
| U.S. Pat. No. 4,487,462 | Jan. 24, 1983 | Dec. 11, 1984 | Stanley Aviation Corp. | Threaded coupling |
| | | | | bonding jumper |
| U.S. Pat. No. 4,808,117 | Sep. 8, 1987 | Feb. 28, 1989 | Stanley Aviation Corp. | Coupler with |
| | | | | combination locking and bonding ring |
| U.S. Pat. No. 4,928,202 | Dec. 12, 1988 | May 22, 1990 | Stanley Aviation Corp. | Coupler with |
| | | | | combination locking and bonding ring |
| U.S. Pat. No. 6,883,836 | Jan. 17, 2003 | Apr. 26, 2005 | Stanley Aviation Corp. | Positive locking fitting |
| | | | | assembly |
| USD575348 | Jan. 12, 2007 | Aug. 19, 2008 | Seiko Epson Corp. | Portable display unit |
| USD575827 | Jan. 12, 2007 | Aug. 26, 2008 | Seiko Epson Corp. | Portable display unit |
| USD582985 | Jan. 12, 2007 | Dec. 16, 2008 | Seiko Epson Corp. | Portable display unit |
| USD583418 | Jan. 12, 2007 | Dec. 23, 2008 | Seiko Epson Corp. | Portable display unit |
| USD591557 | Sep. 25, 2008 | May 5, 2009 | Pi-Design, AGGrip for beverage | |
| | | | containers such as a glasses or jugs | |
| USD596452 | Jan. 19, 2008 | Jul. 21, 2009 | Pan support | |
| USD613600 | Feb. 19, 2008 | Apr. 13, 2010 | Aerosol can stand | |

3,926,494 Maillero 1975

Typical electric plugs and data cords have several common usage problems that grip wings can improve or solve.

For many people, typical electric plugs and data cords are difficult to use. This includes anyone with reduced grip strength, immobile fingers, and/or limited dexterity, such as: the disabled, the elderly, children, and workers who must wear gloves.

The prongs of electrical plugs can expose adults, youth, and children to dangerous electrical current when partially inserted into an electrical outlet or receptable.

Most electrical and data plugs must be oriented correctly to fit their outlets, and the required orientation is often not obvious. The grip wings can give users more control to push or pull electrical plugs and data plugs in and out of their sockets safely.

In addition, the grip wings must maintain the integrity of the electrical plug, cord material, and any components that are or may be affected by the grip wings.

### SUMMARY

The electrical plug grip wings consist of two parts: a rigid handle, and an attachment of the handle to the electric plug or data cord plug.

The grip wings can be embodied in several ways:
1. An accessory to existing electrical plugs or data cord plugs
   a) a handle, either bar [101] or loop [102], attached with adhesive (FIGS. 1A and 1B)
   b) an adapter plug [103] (FIG. 1C)
   c) a replacement plug [104] (FIG. 1D)
2. Inclusion in the original manufacturing of the plug [105] [106] (FIGS. 2A and 2B)

The electrical plug grip wings can apply to both consumer [105] (FIG. 2A) and industrial [106] (FIG. 2B) electric plugs. Different materials and dimensions can be selected that are appropriate to the sizes and forces involved in each application. The consumer application is further described in this specifications section.

### ADVANTAGES

Typical electric plug insertion or withdrawal from an electric outlet requires grip strength to apply friction force to the sides of the plug. People with low grip strength can be frustrated by, or unable to use, standard electric plugs. The grip wings provide an extension that is perpendicular to the insertion and withdrawal force, giving a push and pull handle for the user, eliminating the need for grip strength. This enables more people to easily and safely use electrical plugs.

The relatively smooth sides of standard electric plugs expose the energized prongs while they are partially inserted into an electrical outlet or receptacle. When inserting the plug, the fingers can slip along the plug and accidentally contact the energized prongs, which electrically shock the user. The push/pull surfaces of the grip wings give fixed placement and a stop for the fingers away from the prongs. This greatly reduces the chance of contacting the energized or electrically-charged prongs.

Many power plugs can be inserted only one way into an outlet. Examples are polarized plugs, with one prong wider than the other, and grounded plugs, with a third prong. The grip wings give visual and tactile indication of the top of the plug, so that alignment is correct when the grip wings are up. This simplifies plug insertion.

Data and power plugs for electronic items, such as cell phones, are often very small and must be oriented correctly to fit into their outlets. They require fine motor control in the fingers, grip strength and close vision to insert successfully. The addition of these grip wings provides a large surface for holding the plug. Pushing and pulling of the grip wings are used to insert the electrical plug. Fine motor control and grip strength are eliminated from the handling of the plug. The shape of these grip wings provides easy orientation of the top of the plug. Close vision is not required to orient the plug correctly. Motor control and vision skills can be concentrated on the single task of aiming the plug at the small electrical outlet.

We must maintain the integrity of the original electrical cord or plug unit. Manufacturers of electric devices instruct users to pull only on the plug and not pull on the cord when withdrawing the plug from an outlet, to prevent the hazardous breakage of internal electric wires. The grip wings maintain that standard by attaching to the plug, so that forces in use are applied to the plug and not to the cord. Also, the grip wings neither touch the prongs of the plug nor alter the electrical functions of the plug or its electrical approvals.

### VERSATILE FUNCTIONAL OPTIONS

The device can be adapted to any type of plug. It can be applied to, or included in, the plugs for all voltages and prong arrangements, including international (FIG. 3). The size of the grip wings and the amount of adhesive can be adjusted to fit any size plug. The prong arrangement can be made to match any standard arrangement worldwide.

The grip wings can be made in a variety of shapes, and with a variety of surface textures, to appeal to many preferences. Where the figures in this document show a smooth rectangular bar, any shape can be substituted, that maintains the push-pull capability along the axis of the plug. It could be shaped like a barbell [107], an oval [108], wings, or mouse ears [109], for example (FIG. 4A, 4B, and 4C). Finger indentations can be given in the edges of the grip wings [101] (see various Figs.). The surface can be made smooth or textured, and can be made hard or soft, as long as the grip wings functional grip-ability and internal stiffness is maintained

Textures and shapes of the grip wings indicate its orientation, so a person can immediately feel if the plug is oriented correctly to fit the outlet. For example, a Braille word could be applied to the top of the device [101] (see various Figures). The raised points would indicate to the blind, and the sighted alike, which side is the top.

The grip wings could be made as a base and cover assembly: an internal rigid base [110], mounted to the plug, with separate external covers [111] attached to the base, either permanently, or changeably (FIG. 5A & 5B). This would allow users to customize and change the look and feel of their grip wings. The unique look of the grip wings could be associated with the equipment that operates on its plug. For instance, a printer could have a different looking grip wings than a computer; or the words themselves, “PRINTER” and “COMPUTER” [112], could be applied to the grip wings (FIG. 5C). Any words, figures, shapes or “skins” could be attached to the base grip wings.

The grip wings could be made to illuminate or made with translucent material and include internal light circuitry that is activated when the plug is energized in an outlet. This feature could be used to confirm that the plug is electrically connected to the outlet; to provide a night light; or to provide amusement. The grip wings could include a switch so the light is selectable.

The grip wings could include an internal rechargable battery, which would allow the grip grip wings to illuminate while not connected to an outlet. This feature could assist a person in seeing the outlet when inserting the plug. The battery would be charged while the plug is energized by an outlet. The circuit would time out when not connected to an outlet, and turn off to save battery power. The grip wings could include a separate light, maybe a different color, that is lit only when the plug is energized to confirm the electrical connection.

If the axis of the grip wings are considered to be horizontal, then the vertical location of the grip wings on the plug can be varied to appeal to different preferences. It can be mounted or molded on the top of the plug [113], or on the bottom of plug [114]. It can be molded in the middle of the plug [115] (FIG. 6A). The middle location will give the most balanced application of force to the plug when inserting or withdrawing it from an outlet, but any of these positions will work.

The axis of the grip wings can be rotated away from horizontal, around the axis of the plug and cord. This orientation would allow for closer proximity of plugs with these grip wings, as the grip wings could overlap. An example is where plugs are inserted in an electrical power strip (FIG. 6B).

### INITIAL EMBODIMENT

The initial preferred embodiment of the grip wings are an accessory to existing plugs, as a handle attached with adhesive. This embodiment is adaptable to most shapes, sizes and prong arrangements of existing plugs. Examples of use: on standard 2 and 3 prong plugs (FIG. 7A), on a right-angle plug (FIG. 7B), on a transformer plug (FIG. 7C), and on a data plug (FIG. 7D). This embodiment consists of a rigid bar [101], and a strip of adhesive [116] bonded to the bar. The adhesive can be provided on tape [116] (FIG. 8A) or as a paste [117] (FIG. 8B).

The dimensions of the bar [101] should give enough volume for ease of grip without becoming obtrusively large. The bar is given a V-notch across its width, centered on the bottom. Adhesive is bonded to the bottom center of the bar conforming to the V-notch. Tape [116] can be provided in an H shape. The length of the H-tape legs allows for wrapping the tape around an assortment of plugs. The bar [101] and the H-tape [116] are arranged parallel and centered with each other. The center of the H tape is bonded to the top of the bar for a permanent, strong bond (FIG. 8A). All of the adhesive is covered by a release liner.

Thermoplastic material is preferred for the grip wings [101] because it is more recyclable than thermosetting plastic, while keeping the proper rigidity and economy that is desired. Any other material can be used, that preserves the grip wings functions, to meet manufacturing or marketing goals. The adhesive tape [116] needs the following properties for performance and ease of use. It is a pressure sensitive tape so that the user does not need to cure it with heat or light or to apply a liquid. The tape has a single-sided adhesive covered by a release liner. The adhesive is permanent and high strength, since the grip wings must endure for years of use and abuse. It adheres to low surface energy plastics such as polyethylene, which is a common plug material. (The characteristic low surface energy of the plastics of plugs makes them good insulators, but also makes them difficult for adhesion.) The adhesive bonds to its own backing material for overwrap adhesion. The tape allows for high conformability to irregular shapes. Adhesive paste [117] needs similar properties.

To apply the grip wings [101], the plug is held in its normal orientation, as if ready to insert into an outlet. The grip wings are held with the adhesive [116] down. The grip wings are positioned on the plug body, not the cord, away from the prongs. On plugs that have prongs parallel with the cord, the grip wings are positioned at least a finger width back from the prong face of the plug (FIG. 7A & 7D). On plugs that have prongs perpendicular to the cord, the grip wings are positioned slightly below the prongs, so the tape wrap will not touch the prongs (FIG. 7B).

The rigid grip wings [101] are oriented perpendicular to the line of the cord and plug and centered on the plug. The ends of the tape [116] hang loosely on opposite sides of the plug.

The release liner is removed to uncover the adhesive. The adhesive on the bottom of the grip wings are pressed against the plug. The tape is wrapped around the plug, with the two halves of the tape wrapping in opposite directions, enveloping the plug. The tape is primarily applied to the plug body, avoiding the cord and avoiding the prong face of the plug. In the case of right-angle type plugs, the tape is wrapped below the prongs, not touching them (FIG. 7B).

To use the grip wings [101] on plugs that are grouped closely in multiple outlets, the grip wings should-be rotated relative to the plug when installing. The notch on the bottom of the grip wings can be pressed against the edge of the plug. This allows multiple grip wings to overlap (FIG. 6B).

### FIGURES

FIG. 1A shows a bar [101] attached with adhesive.

FIG. 1B shows a loop [102] attached with adhesive.

FIG. 1C shows an adapter plug [103].

FIG. 1D shows a replacement plug [104].

FIG. 2A shows the grip wings included in a consumer plug [105].

FIG. 2B shows the grip wings included in an industrial plug [106].

FIG. 3 shows the grip wings [101] on an international plug.

FIG. 4A shows the grip wings in a barbell shape [107].

FIG. 4B shows the grip wings in an oval shape [108].

FIG. 4C shows the grip wings in a mouse shape [109].

FIG. 5A shows the base grip wings [110] attached to a plug.

FIG. 5B shows the grip wings cover [111] assembled on the base,

FIG. 5C shows the grip wings [101] with a word label [112],

FIG. 6A shows the grip wings in top [113], middle [115] and bottom [114] locations on the plug.

FIG. 6B shows the grip wings [101] rotated on plugs in close proximity.

FIG. 7A shows the grip wings [101] on a standard 3 prong plug.

FIG. 7B shows the grip wings [101] on a right angle plug.

FIG. 7C shows the grip wings [101] on a transformer plug.

FIG. 7D shows the grip wings [101] on a data plug.

FIG. 8A shows the grip wings [101] as an accessory with adhesive tape [116].

FIG. 8B shows the grip wings [101] as an accessory with adhesive paste [117].

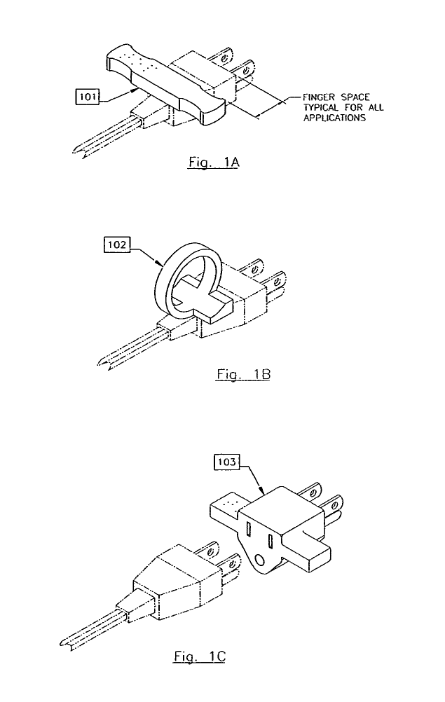

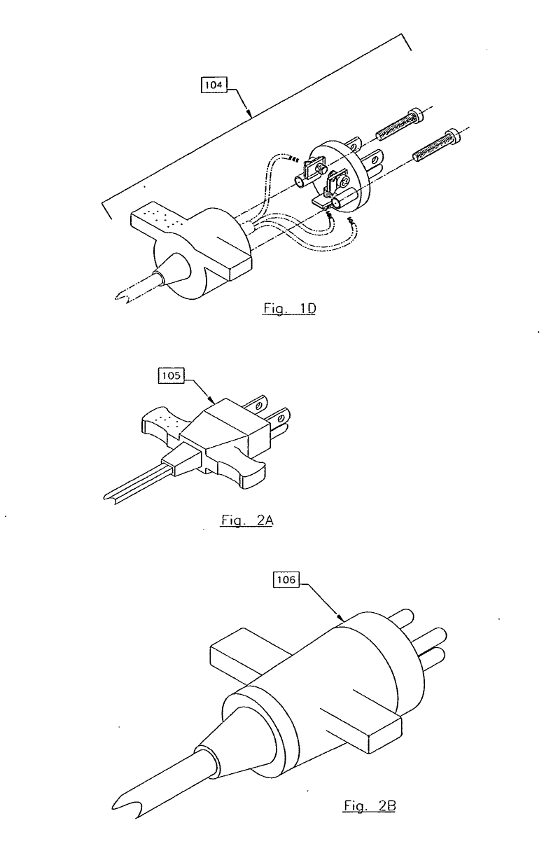

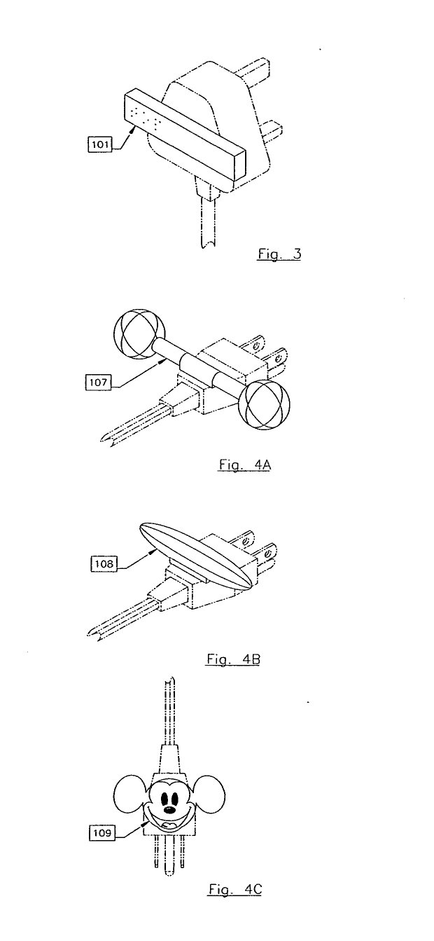

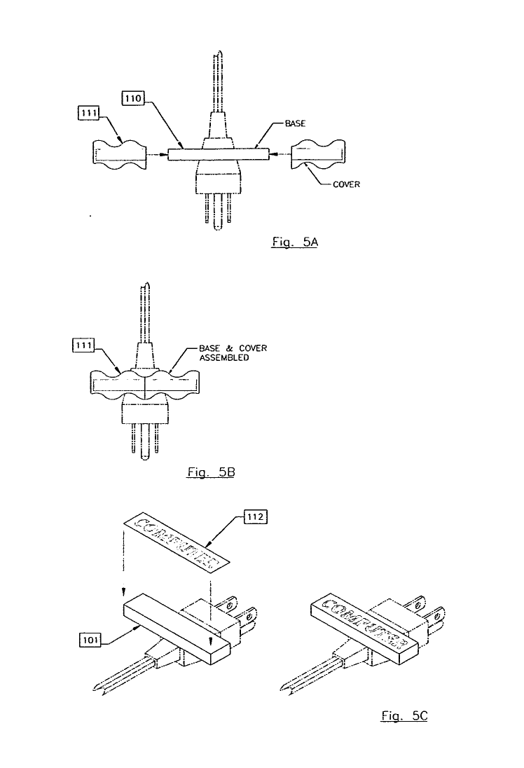

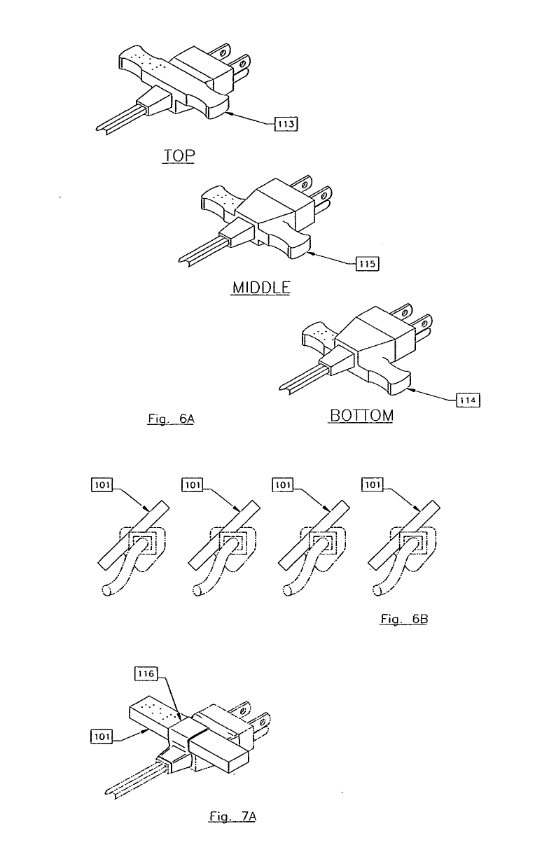

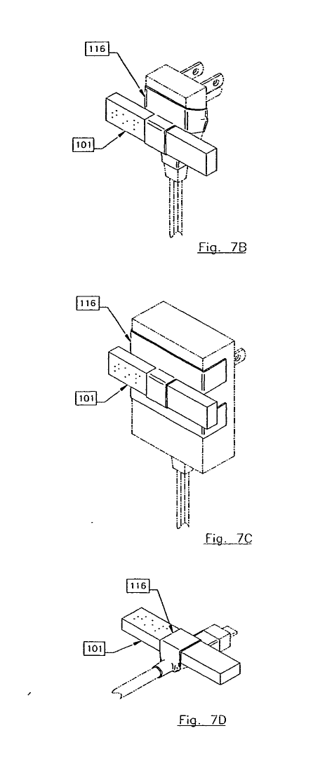

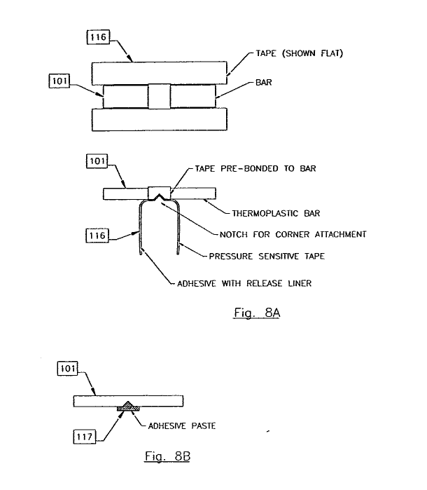

1. A device for the safe and easy removal of an electrical plug or data cord plug comprisiing:
a. grip wings located far enough back from the male body of the plug where the prongs come out so that a person can push against the back of the grip wings to insert plug, and pull against the front of the grip wings to remove the plug from its receptacle.
b. grip wings located to give visual and tactile indication of the top of the plug for correct alignment with plug receptacle
c. grip wings which are built into any type of plug as an OEM
d. grip wings which can be attached to any type plug
